(19) United States
(12) Patent Application Publication
(10) Pub. No.: US 2023/0290209 A1
(43) Pub. Date: Sep. 14, 2023

(54) COIN STORAGE METHOD AND COIN STORAGE APPARATUS

(71) Applicant: GLORY LTD., Hyogo (JP)

(72) Inventor: Takuro HAMADA, Hyogo (JP)

(21) Appl. No.: 18/182,678

(22) Filed: Mar. 13, 2023

(30) Foreign Application Priority Data
Mar. 14, 2022 (JP) 2022-039209

(51) Int. Cl. G07D 1/06

(52) U.S. Cl. CPC G07D 1/06; G07D 2201/00

(57) ABSTRACT

Provided is a coin storage method that is executed by a processor of a coin storage apparatus. The coin storage method includes: feeding out a coin from a first storage unit that stores a coin; recognizing a denomination of the coin that has been fed out; executing, based on a number of coins, which have been already stored in a second storage unit that stores a coin to be withdrawn outside, for each denomination and the denomination of the coin having been recognized, a replenishment operation in which the coin is selectively stored in a second storage unit; and changing, depending on the denomination of the coin having been fed out from the first storage unit, a denomination/number-of-coins combination of one or a plurality of coins to be stored in the second storage unit in the replenishment operation.

### CROSS-REFERENCE TO RELATED APPLICATIONS

This application is entitled and claims the benefit of Japanese Patent Application No. 2022-039209, filed on Mar. 14, 2022, the disclosure of which including the specification, drawings and abstract is incorporated herein by reference in its entirety.

### BACKGROUND

Some automatic settlement machines that receives various payments such as the price of a commodity, compensation for a service, a fare, or medical expenses have a function of automatically dispensing a difference between a deposited amount and a payment amount as change.

For example, conventionally, there has been known a coin handling apparatus that performs coin handling such as recognition, counting, dispensing and the like of coins, and that selectively stores a plurality of coins of a plurality of denominations necessary for change in a storing unit from a storage unit.

### SUMMARY

A coin storage method according to the present disclosure comprises: feeding out a coin from a first storage unit that stores a coin; recognizing a denomination of the coin that has been fed out; and executing, based on a number of coins for each denomination having been already stored in a second storage unit and the denomination of the coin recognized, a replenishment operation in which the coin is selectively stored in the second storage unit, wherein the second storage unit storing a coin to be withdrawn outside, wherein the executing of the replenishment operation further comprises changing, depending on the denomination of the coin having been fed out from the first storage unit, a denomination/number-of-coins combination of one or a plurality of coins to be stored in the second storage unit in the replenishment operation.

### BRIEF DESCRIPTION OF DRAWINGS

FIG. 1 is a conceptual diagram illustrating an example of a configuration of a coin storage apparatus;

FIG. 2A is a schematic cross-sectional view of a second storage unit in a state in which a door is closed;

FIG. 2B is a schematic cross-sectional view of the second storage unit in a state in which the door opens;

FIG. 3 is a flowchart provided for describing an outline of a replenishment operation;

FIG. 4 is a conceptual diagram illustrating an example of a structure of the coin storage apparatus;

FIG. 5A is a diagram provided for describing a deposit operation in which a coin is deposited from outside of the coin storage apparatus;

FIG. 5B is a diagram provided for describing a withdrawal operation in which a coin is withdrawn from the second storage unit in the coin storage apparatus;

FIG. 5C is a diagram provided for describing the replenishment operation in which the second storage unit is replenished with a coin from a first storage unit;

FIG. 5D is a diagram provided for describing a collection operation in which a manager of the coin storage apparatus collects a coin stored in the first storage unit;

FIG. 6A illustrates combinations each of which is a combination of the number of one-cent coins, the number of two-cent coins, and the number of five-cent coins, where the respective coins contribute to the one cents place of change;

FIG. 6B illustrates combinations each of which is a combination of the number of ten-cent coins, the number of twenty-cent coins, and the number of fifty-cent coins, where the respective coins contribute to the ten cents place of change;

FIG. 6C illustrates combinations each of which is a combination of the number of one-euro coins and the number of two-euro coins, where the respective coins contribute to the one euros (hundred cents) place;

FIG. 7 illustrates examples of upper limit numbers;

FIG. 8 is a flowchart provided for describing determination of a CPU in the replenishment operation;

FIG. 9 is a conceptual diagram illustrating an example of a structure of the coin storage apparatus; and

FIG. 10 is a flowchart provided for describing an example of a flow of an entire operation.

### DESCRIPTION OF EMBODIMENTS

The coin handling apparatus disclosed in PTL 1 stores, as a fund, coins of respective denominations for change in the storing unit, where a predetermined number of coins for each denomination are stored therein. Accordingly, it is possible to promptly dispense change when the change is needed to be dispensed.

When a coin handling apparatus stores a fund in a storing unit, it is necessary to repeat feeding out of coins from a storage unit and recognition of the coins until a coin of a predetermined denomination is stored in the storing unit. An object of the present disclosure is to provide a coin storage method and a coin storage apparatus each capable of efficiently storing a coin of a specific denomination.

In the coin storage method according to the present disclosure, the executing of the replenishment operation may further comprise storing the coin recognized in the second storage unit until the denomination/number-of-coins combination of the plurality of coins stored in the second storage unit matches a denomination/number-of-coins combination indicated by at least one of the plurality of denomination/number-of- coins patterns, among a plurality of denomination/number-of-coins patterns indicating a plurality of denomination/number-of-coins combinations set in advance.

In the coin storage method according to the present disclosure, the executing of the replenishment operation may further comprise returning the coin recognized to the first storage unit after a number of the plurality of coins stored in the second storage unit for each denomination matches the denomination/number-of-coins combination indicated by one of the plurality of denomination/number-of- coins patterns.

In the coin storage method according to the present disclosure, the executing of the replenishment operation may further comprise returning a coin of a specific denomination, among a plurality of the coins recognized, to the first storage unit, when a number of coins of the specific denomination among the plurality of coins stored in the second storage unit has reached an upper limit number set in advance for each denomination.

In the coin storage method according to the present disclosure, the upper limit number may be a maximum value of a number of coins for each denomination indicated by the plurality of denomination/number-of- coins patterns.

In the coin storage method according to the present disclosure, wherein the executing of the replenishment operation may further comprise: receiving selection of at least one specific denomination/number-of-coins pattern among the plurality of denomination/number-of-coins patterns, and storing the coin recognized in the second storage unit until the number of the plurality of coins stored in the second storage unit for each denomination matches a number-of-coins combination for the each denomination indicated by the at least one specific denomination/number-of-coins pattern selected.

In the coin storage method according to the present disclosure, the executing of the replenishment operation may further comprise: selecting at least one specific denomination/number-of-coins pattern among the plurality of denomination/number-of-coins patterns based on an operation mode set in advance, and storing the coin recognized in the second storage unit until the number of the plurality of coins stored in the second storage unit for each denomination matches a number-of-coins combination for the each denomination indicated by the at least one specific denomination/number-of-coins pattern having been selected.

In the coin storage method according to the present disclosure, the executing of the replenishment operation may further comprise feeding out the one or plurality of coins from the second storage unit and, transpoting one or a plurality of coins that forms an amount of the withdrawal requested, among the one or plurality of coins fed out, to an outlet, when withdrawal is requested, wherein each of the plurality of denomination/number-of-coins patterns indicates a number-of-coins combination for the each denomination, the number-of-coins combination forming a withdrawal fund to be stored in the second storage unit.

In the coin storage method according to the present disclosure, the executing of the replenishment operation may further comprise feeding out a coin anew from the first storage unit, recogniging, and transporting a coin to the second storage unit, after transportating the plurality of coins forming the amount of the withdrawal to the outlet.

In the coin storage method according to the present disclosure, the executing of the replenishment operation may further comprise at least one of a deposit and/or a withdrawal at the coin storage apparatus is stopped until the number of the plurality of coins stored in the second storage unit for each denomination matches the number-of-coins combination for the each denomination indicated by, among the plurality of denomination/number-of-coins patterns set in advance, at least one of the plurality of denomination/number-of-coins patterns, after transporting the plurality of coins forming the amount of the withdrawal to the outlet.

A coin storage apparatus according to the present disclosure comprises: a first storage unit that stores a plurality of coins of a plurality of denominations; a second storage unit that stores a coin independently of the first storage unit; an outlet through which a coin is withdrawn outside; a transport unit that transports the coin or the plurality of coins; a feeding unit that feeds out the coin or the plurality of coins, which has been discharged from the first storage unit and the second storage unit, to the transport unit; a recognition unit that recognizes a denomination or denominations of the coin or the plurality of coins to be transported; and a control unit that causes at least one or some of the plurality of coins discharged from the first storage unit to be stored in the second storage unit and causes at least one or some of a plurality of the coins discharged from the second storage unit to the feeding unit to be withdrawn through the outlet.

In the coin storage apparatus according to the present disclosure, the feeding unit that feeds out the coin or the plurality of coins to the transport unit may be provided on a lower side of the second storage unit and close to the second storage unit.

In the coin storage apparatus according to the present disclosure, the control unit may further cause the plurality of coins having been discharged from the first storage unit and having been recognized to be stored in the second storage unit until a number of a plurality of coins, which is stored in the second storage unit, for each denomination matches a number-of-coins combination for the each denomination indicated by, among a plurality of denomination/number-of-coins patterns having been set in advance, at least one of the plurality of denomination/number-of- coins patterns.

In the coin storage apparatus according to the present disclosure, the control unit may further cause the coin or the plurality of coins, which has been recognized, to be returned to the first storage unit after a number of a plurality of coins, which has been stored in the second storage unit, for each denomination matches the denomination/number-of-coins combination indicated by one of the plurality of denomination/number-of- coins patterns.

In the coin storage apparatus according to the present disclosure, the second storage unit may comprise a bottom part, which is openable and closable, and may cause the coin or the plurality of coins to fall to the feeding unit by opening the bottom part when a withdrawal is performed.

Note that, in the coin storage method and apparatus according to the present disclosure, a denomination/number-of-coins pattern indicating a combination of coins for each denomination, which forms a withdrawal fund that is stored in the second storage unit, may also be defined by the number of coins for each denomination, which can be withdrawn as change, regardless of a monetary amount whose withdrawal is requested as the change. For example, in the case of the yen, coins for 999 yen suffice as coins usually prepared as change since there are banknotes for values equal to or greater than 1000 yen. In the coin storage method and apparatus according to the present disclosure, however, a denomination/number-of-coins pattern that allows change greater than 999 yen to be withdrawn (for example, a pattern that allows coins up to 1500 yen to be withdrawn as change) may be set.

In the coin storage method and apparatus according to the present disclosure, a denomination/number-of-coins pattern is automatically selected in accordance with the denomination(s) and number of coins that are stored in the second storage unit. However, it may also be configured such that, for example, the user of the coin storage apparatus can freely set the coin storage apparatus as to which denomination/number-of-coins pattern among a plurality of denomination/number-of- coins patterns is used. Further, it may also be configured such that a denomination/number-of-coins pattern can be freely set in accordance with the user’s intention, such as withdrawing or not withdrawing only a coin(s) of a specific denomination.

According to the present disclosure, a coin of a specific denomination can be stored efficiently.

Hereinafter, embodiments of the present disclosure will be described with reference to the accompanying drawings. However, detailed descriptions of already well-known matters, duplicated descriptions of substantially the same configuration, or the like may be omitted. Further, configurations common in the embodiments are denoted by the same reference signs, and duplicated descriptions thereof may be omitted. A “unit” as used in this disclosure includes a physical structure.

### <Embodiment 1>

### [Configuration Example]

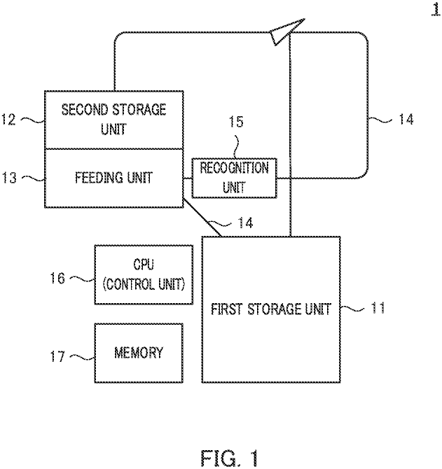

FIG. 1 is a conceptual diagram illustrating an example of a configuration of a coin storage apparatus 1 according to Embodiment 1. As illustrated in FIG. 1, the coin storage apparatus 1 comprises a first storage unit 11, a second storage unit 12, a feeding unit 13, a transport unit 14, a recognition unit 15, a CPU 16, and a memory 17.

The first storage unit 11 stores a plurality of coins of a plurality of denominations in a mixed manner. Further, the first storage unit 11 is capable of discharging a coin that has been stored therein. For example, a coin is discharged from the first storage unit 11 to the feeding unit 13.

The second storage unit 12 stores a plurality of coins of a plurality of denominations in a mixed manner. Further, the second storage unit 12 is capable of discharging a coin that has been stored therein. For example, a coin is discharged from the second storage unit 12 to the feeding unit 13.

The second storage unit 12 stores, among the plurality of coins stored in the first storage unit 11, one or some coin(s) discharged from the first storage unit 11. The coin stored in the second storage unit 12 is used as, for example, a change fund. The change fund is an example of the withdrawal fund of the present disclosure.

The feeding unit 13 sequentially feeds out coins, which have been discharged from the first storage unit 11 or the second storage unit 12, one by one to the transport unit 14. The feeding unit 13 is provided, for example, on a lower side of the second storage unit 12 and close to the second storage unit 12. Thus, a coin that has been discharged from the second storage unit 12 is immediately inputted into the feeding unit 13, and thus, it is possible to promptly perform feeding out of the coin from the second storage unit 12 to the transport unit 14.

The transport unit 14 transports a coin, which has been fed out from the feeding unit 13, along a first transport path and a second transport path. The transport unit 14 transports the coin to the first storage unit 11 along the first transport path. The transport unit 14 transports the coin to the second storage unit 12 along the second transport path. The transport unit 14 transports the coin by using, for example, belts.

The recognition unit 15 is a unit that recognizes the denomination, authenticity, fitness, or the like of a coin transported by the transport unit 14. Further, the recognition unit 15 may have a function of counting the number of coins transported by the transport unit 14.

The CPU (Central Processing Unit) 16 is a processor that performs operation control of each part of the coin storage apparatus 1. The CPU 16 is an example of the processor and the control unit of the present disclosure. The basic programmes (operating system) and various settings and the like, executed by the CPU, are stored in ROM, the CPU uses RAM as a work area and executes the application programmes read from the ROM.

The memory 17 stores various information necessary for various operations of the coin storage apparatus 1. As examples of the information stored in the memory 17, it is possible to mention first denomination/number-of-coins information indicating the number of coins for each denomination stored in the first storage unit 11 at that point in time, second denomination/number-of-coins information indicating the number of coins for each denomination stored in the second storage unit 12 at that point in time, or the like.

### [Configuration Example of Second Storage Unit]

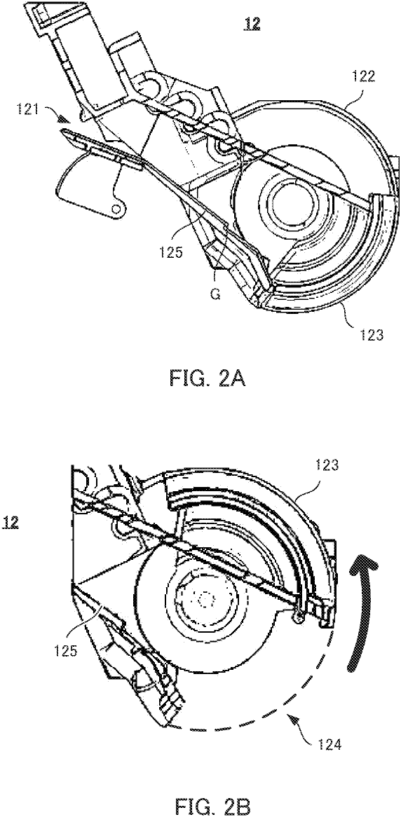

An example of a configuration of the second storage unit 12 will be described. FIGS. 2A and 2B are schematic cross-sectional views of the second storage unit 12. As illustrated in FIGS. 2A and 2B, the second storage unit 12 comprises an inlet 121, a coin stacking unit 122, and a door 123. FIG. 2A illustrates the second storage unit 12 in a state in which the door 123 is closed and FIG. 2B illustrates the second storage unit 12 in a state in which the door 123 is open. In FIG. 2B, illustration of a portion of an upper part of the second storage unit 12, which comprises the inlet 121, is omitted.

The inlet 121 is, for example, an opening through which a coin deposited into the second storage unit 12 via the transport unit 14 is received.

The coin stacking unit 122 is a space whose cross-sectional shape is a substantially circular shape, and is provided with an opening 124 in a lower part. The opening 124 is configured to be openable and closable by the door 123. The feeding unit 13 is disposed on a lower side of the opening 124.

The door 123 is a door that opens and closes the opening 124 provided in the lower part of the coin stacking unit 122. The door 123 forms a part of an arc of the cross-sectional shape, which is formed in a substantially circular shape, of the coin stacking unit 122 and is configured to be rotatable around a substantially center part of the cross-sectional shape of the coin stacking unit 122 as a center of rotation (see the arrow in FIG. 2B). The door 123 in the closed state closes the opening 124 of the coin stacking unit 122, and at least one or some of coins stacked in the coin stacking unit 122 is/are stacked on the door 123 in the closed state. In a case that the door 123 opens, the coin(s) stacked in the coin stacking unit 122 fall(s) and is/are discharged to the feeding unit 13.

The coin stacking unit 122 comprises a support plate 125 that guides a coin, which has been deposited through the inlet 121, to the coin stacking unit 122 and supports coins stacked in the coin stacking unit 122. As illustrated in FIGS. 2A and 2B, the support plate 125 is obliquely disposed on the whole, which makes it possible to avoid a situation in which a coin remains near the inlet 121 since a coin, which has been deposited through the inlet 121, slides down along the support plate 125 to the coin stacking unit 122.

The support plate 125 is curved in a cross-sectional shape such that its angle formed with the horizontal plane increases as the support plate 125 approaches the coin stacking unit 122. The support plate 125 may be curved smoothly or may be formed, in the cross-sectional shape, of a combination of a plurality of straight lines in which its angle formed with the horizontal plane gradually increases. Further, the support plate 125 comprises a step G whose part closer to the coin stacking unit 122 is shifted to a lower side. Thus, when a plurality of coins is stacked in the coin stacking unit 122, it is possible to prevent a situation in which the plurality of coins is arranged from a lower side to an upper side along the support plate 125.

### [Operation Example]

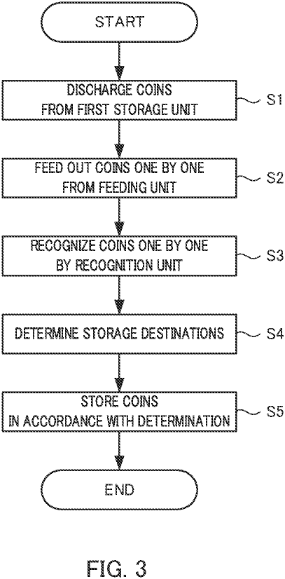

Operations of the coin storage apparatus 1 comprising the configuration as described above are, for example, as follows. FIG. 3 is a flowchart provided for describing an outline of, as an example of the operations of the coin storage apparatus 1, a replenishment operation in which the second storage unit 12 is replenished with a coin stored in the first storage unit 11. Note that, it is assumed in the replenishment operation illustrated in FIG. 3 that at the starting point in time, each of a plurality of denominations comprises a plurality of coins stored in the first storage unit 11.

In step S1, the CPU 16 causes a coin(s) to be discharged from the first storage unit 11. At this time, the CPU 16 causes the first storage unit 11 to discharge the coin(s) regardless of the denomination(s). Note that, the following description will be made on the assumption that the CPU 16 causes a plurality of coins to be discharged from the first storage unit 11, but the same operation can be applied, for example, in a case where the CPU 16 causes one coin to be discharged from the first storage unit 11.

In step S2, the CPU 16 causes the coins, which have been discharged from the first storage unit 11, to be sequentially fed out one by one from the feeding unit 13.

In step S3, the CPU 16 causes the recognition unit 15 to sequentially recognize the denominations of the coins, which have been fed out by the feeding unit 13, one by one. Note that, in this step, the recognition unit 15 may recognize, in addition to the denomination, at least one of the authenticity and/or the fitness of the coins. In a case where the recognition unit 15 has recognized a coin as a forged coin or a damaged coin, the CPU 16 does not subject the coin to the subsequent replenishment operation by causing the coin to be discharged from the coin storage apparatus 1 or to be stored in a dedicated storage unit (different from the first storage unit 11 and the second storage unit 12).

In step S4, the CPU 16 determines storage destinations for the recognized coins. More specifically, the CPU 16 refers to the second denomination/number-of-coins information at that point in time and determines whether the recognized coins are stored in the second storage unit 12 or are returned to the first storage unit 11 based on the number of coins for each determination, which have been already stored in the second storage unit 12 at that point in time, and the denominations of the coins recognized in step S3. Details of the determination of the CPU 16 in step S4 will be described in detail in Embodiment 3.

In step S5, the CPU 16 causes the recognized coins to be stored in accordance with the determination in step S4. More specifically, in a case where the CPU 16 has determined that a recognized coin is stored in the second storage unit 12, the CPU 16 causes the recognized coin to be transported to the second storage unit 12 and to be stored in the second storage unit 12. Further, in a case where the CPU 16 has determined that a recognized coin is returned to the first storage unit 11, the CPU 16 causes the recognized coin to be transported to the first storage unit 11 and to be stored in the first storage unit 11.

As described above, the coin storage apparatus 1 according to Embodiment 1 comprises two storage units independent of each other. The first storage unit 11 stores a plurality of coins of a plurality of denominations regardless of the number of the coins, and the second storage unit 12 stores one or some coin(s) discharged from the first storage unit 11. The coin(s) that is/are stored in the second storage unit 12 is/are used for, for example, a change fund or the like. In a case where a coin(s) that has/have been stored in the second storage unit 12 is/are withdrawn as change or the like, the second storage unit 12 is replenished with a coin(s) from the first storage unit 11. However, although details will be described in Embodiment 3, the number of coins for each denomination, with which the second storage unit 12 is replenished, is not always constant and may properly vary based on the number of coins for each denomination remaining in the second storage unit 12, the denomination(s) of a coin(s) fed out from the first storage unit 11, or the like.

Such a configuration makes it possible to reduce the number of storage units in comparison with a case where a coin storage apparatus comprises, for example, different storage units for each denomination. For example, in an area where the yen is in circulation as a currency, six kinds of coins: one-yen coin, five-yen coin, ten-yen coin, fifty-yen coin, hundred-yen coin, and five-hundred-yen coin are generally in circulation, and thus, six storage units are required in a case where the respective kinds of coins are stored in separate storage units. Further, in an area where the euro is in circulation as a currency, eight kinds of coins: one-cent coin, two-cent coin, five-cent coin, ten-cent coin, twenty-cent coin, fifty-cent coin, one-euro coin, and two-euro coin are generally in circulation, and thus, eight storage units are required in a case where the respective kinds of coins are stored in separate storage units. Since the number of storage units is only two according to the coin storage apparatus 1 according to Embodiment 1, it is possible to reduce the size of the coin storage apparatus 1 in comparison with a case where a coin storage apparatus comprises, for example, different storage units for each denomination.

### <Embodiment 2>

In Embodiment 2, a structure of the coin storage apparatus of the present disclosure will be described in more detail.

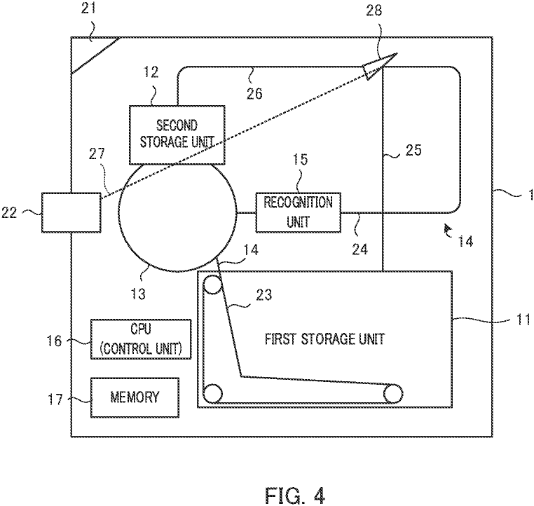

FIG. 4 is a conceptual diagram illustrating an example of a structure of the coin storage apparatus 1.

The coin storage apparatus 1 according to Embodiment 2 comprises, in addition to the respective configurations described in Embodiment 1, an inlet 21, an outlet 22, and a discharge mechanism 23.

The inlet 21 is an opening part that receives a deposit from outside of the coin storage apparatus 1. A coin that has been deposited through the inlet 21 is moved to the feeding unit 13.

The outlet 22 is an opening part that withdraws a coin outside of the coin storage apparatus 1.

The discharge mechanism 23 is a mechanism for discharging a coin from the first storage unit 11 to the feeding unit 13. The discharge mechanism 23 is, for example, a conveyor belt provided inside the first storage unit 11.

In Embodiment 2, the feeding unit 13 comprises, for example, a disk comprising a protrusion on the surface. The disk is disposed inclined at a predetermined angle with respect to the vertical direction, and is rotated by a motor or the like while being in an inclined state. When coins enter the feeding unit 13, the coins are stored in a lower part of the disk. As the disk rotates, the coins are hooked one by one to the protrusion and move to an upper side. The coins that have been hooked to the protrusion and have been moved to the upper side are fed out from a hole part provided in an outer peripheral part rather than the disk in the feeding unit 13. The hole part is connected to a common transport path 24 that forms the transport unit 14. With such a configuration, the feeding unit 13 is capable of feeding out coins one by one to the common transport path 24.

Further, in Embodiment 2, the disk of the feeding unit 13 is provided on a lower side of a discharge port of the second storage unit 12 and close to the second storage unit 12. Further, the second storage unit 12 comprises a bottom part that is openable and closable, and when the bottom part opens, a coin stored in the second storage unit 12 falls inside the feeding unit 13 disposed just on the lower side of the second storage unit 12. With such a configuration, a coin that has been discharged from the second storage unit 12 is immediately inputted into the feeding unit 13, and thus, it is possible to shorten a route through which the coin is transported, and further it is possible to promptly perform feeding out of the coin from the second storage unit 12 to the transport unit 14.

The common transport path 24 is a transport path that connects the feeding unit 13 and a diverter unit 28 to be described later. The recognition unit 15 is provided on the common transport path 24. The diverter unit 28 is a portion on the transport path, which causes the transport path to diverge into a plurality of transport paths. The diverter unit 28 causes the transport path to diverge from the common transport path 24 into a first transport path 25, a second transport path 26, and a withdrawal transport path 27.

The first transport path 25 is a transport path that connects the diverter unit 28 and the first storage unit 11. The second transport path 26 is a transport path that connects the diverter unit 28 and the second storage unit 12. The withdrawal transport path 27 is a transport path that connects the diverter unit 28 and the outlet 22. As described above, the transport unit 14 is formed of the transport path comprising the common transport path 24, the first transport path 25, the second transport path 26, and the withdrawal transport path 27.

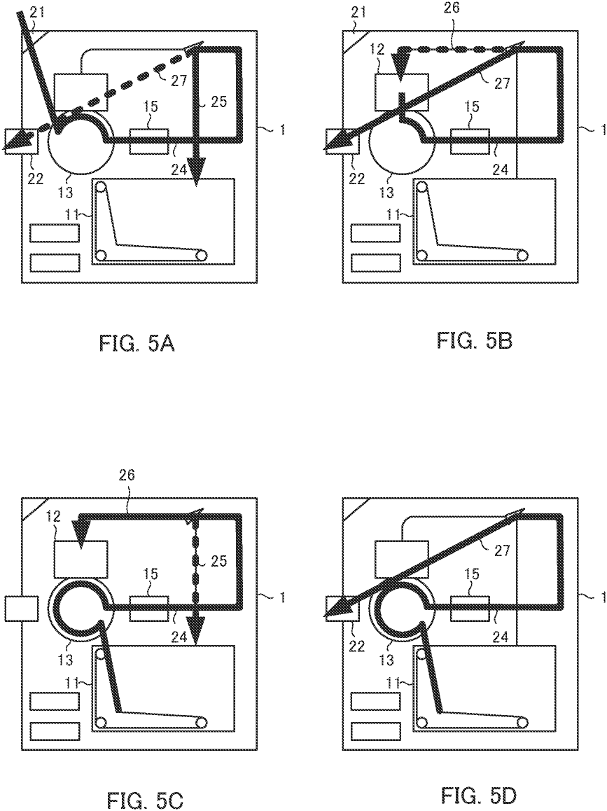

Various operations of the coin storage apparatus 1 of Embodiment 2 will be described with reference to FIGS. 5A to 5D. In FIGS. 5A to 5D, the solid arrows indicate how a coin moves in the respective operations. FIG. 5A is a diagram provided for describing a deposit operation in which a coin is deposited from outside of the coin storage apparatus 1.

As illustrated in FIG. 5A, a coin that has been deposited through the inlet 21 is first inputted into the feeding unit 13. The feeding unit 13 feeds out deposited coins one by one to the common transport path 24. The coins that have been fed out are recognized by the recognition unit 15 on the common transport path 24.

The recognized coin is transported to the first storage unit 11 via the common transport path 24 and the first transport path 25, and is stored in the first storage unit 11. Note that, for example, in a case where the first storage unit 11 is full and can no longer store any new coin, or in a case where a recognized coin that has been stored in the first storage unit 11 turns out to be a coin that should not be stored in the first storage unit 11 as a result of the recognition, or the like, the recognized coin is transported to the outlet 22 via the withdrawal transport path 27 and is refunded as illustrated by the dashed arrow in FIG. 5A.

The first denomination/number-of-coins information indicating the denomination(s) and number of coins that are stored in the first storage unit 11 is stored in a storage section (memory) or the like of the coin storage apparatus 1. The first denomination/number-of-coins information is updated each time the first storage unit 11 stores a coin anew.

Next, FIG. 5B is a diagram provided for describing a withdrawal operation in which a coin is withdrawn from the second storage unit 12 in the coin storage apparatus 1. As described above, the second storage unit 12 stores coins, such as a change fund, for being withdrawn outside of the coin storage apparatus 1. In a case where a withdrawal is requested, the coin storage apparatus 1 withdraws a coin(s) in the requested monetary amount from the second storage unit 12. This withdrawal operation is performed, for example, in a case where the coin storage apparatus 1 is requested from outside to withdraw change, or the like.

As illustrated in FIG. 5B, every coin that has been stored in the second storage unit 12 is first discharged from the second storage unit 12. The coins that have been discharged from the second storage unit 12 are inputted into the feeding unit 13 disposed just on the lower side of the second storage unit 12. The feeding unit 13 feeds out deposited coins one by one into the common transport path 24. The coins that have been fed out are recognized by the recognition unit 15 on the common transport path 24.

The CPU 16 determines whether each recognized coin is withdrawn. In a case where the CPU 16 has determined that a recognized coin is withdrawn, the CPU 16 causes the coin to be transported to the outlet 22 via the common transport path 24 and the withdrawal transport path 27 and to be withdrawn. Further, in a case where the CPU 16 has determined that a recognized coin is not withdrawn, the CPU 16 causes the coin to be returned to the second storage unit 12 via the common transport path 24 and the second transport path 26 as illustrated by the dashed arrow in FIG. 5B.

The method of determining whether a recognized coin is withdrawn is not particularly limited in the present disclosure. However, for example, in a case where an amount obtained by adding a monetary amount of a newly recognized coin(s) to the sum of coins that have been withdrawn hitherto does not exceed a monetary amount whose withdrawal is requested, such as an amount of change, the CPU 16 causes the newly recognized coin(s) to be withdrawn.

Note that, in the above description, it is configured such that every coin is discharged from the second storage unit 12 in the withdrawal operation, but the present disclosure is not limited thereto. For example, it may also be configured such that a set number of coin(s) is/are discharged from the second storage unit 12 in the withdrawal operation. Then, it may also be configured such that in a case where the sum of a monetary amount discharged from the second storage unit 12 is less than a requested monetary amount, the remaining coin(s) is/are discharged from the second storage unit 12.

Next, FIG. 5C is a diagram provided for describing the replenishment operation in which the second storage unit 12 is replenished with a coin from the first storage unit 11. The replenishment operation is an operation for replenishing the second storage unit 12 with a coin for a coin that has been withdrawn from the second storage unit 12 by the withdrawal operation described above. However, the replenishment operation in the coin storage apparatus 1 of the present disclosure is characterized in that the second storage unit 12 is not necessarily replenished with a coin of the same denomination as that of a coin that has been withdrawn from the second storage unit 12. The replenishment operation described in FIG. 5C corresponds to the operation described with reference to FIG. 3 in Embodiment 1.

As illustrated in FIG. 5C, a predetermined number of coins are first discharged from the first storage unit 11. In this case, the first storage unit 11 randomly discharges the predetermined number of coins from coins stored therein. That is, it is assumed that the number of coins for each denomination comprised in coins that are discharged by the first storage unit 11 varies for each replenishment operation.

The predetermined number of coins that have been discharged from the first storage unit 11 are inputted into the feeding unit 13. The feeding unit 13 feeds out deposited coins one by one to the common transport path 24. The coins that have been fed out are recognized by the recognition unit 15 on the common transport path 24.

The CPU 16 determines whether each recognized coin is stored in the second storage unit 12. In a case where the CPU 16 has determined that a recognized coin is stored in the second storage unit 12, the CPU 16 causes the coin to be transported to the second storage unit 12 via the common transport path 24 and the second transport path 26 and to be stored in the second storage unit 12. Further, in a case where the CPU 16 has determined that a recognized coin is not stored in the second storage unit 12, the CPU 16 causes the coin to be returned to the first storage unit 11 via the common transport path 24 and the first transport path 25 as illustrated by the dashed arrow in FIG. 5C. The determination of the CPU 16 in the replenishment operation will be described in detail in Embodiment 3.

The coin storage apparatus 1 is capable of performing settlement of prices by a plurality of users, or the like by repeatedly performing the withdrawal operation and the replenishment operation. The second storage unit 12 may store the number of coins of denominations from which a monetary amount necessary for one withdrawal operation can be formed.

Next, FIG. 5D is a diagram provided for describing a collection operation in which a manager of the coin storage apparatus 1 collects a coin stored in the first storage unit 11. For example, in a case where the coin storage apparatus 1 is an automatic settlement machine, the collection operation of the coin storage apparatus 1 is performed to collect proceeds for sales.

As illustrated in FIG. 5D, coins that have been discharged from the first storage unit 11 are inputted into the feeding unit 13. The feeding unit 13 feeds out deposited coins one by one to the common transport path 24. The coins that have been fed out are recognized by the recognition unit 15 on the common transport path 24.

The recognized coins are transported to the outlet 22 via the common transport path 24 and the withdrawal transport path 27 and are withdrawn. The collection operation is performed, for example, until every coin stored in the first storage unit 11 has been discharged or until a predetermined number of coin(s) stored therein or a predetermined monetary amount stored therein has/have been discharged. For example, the collection operation may be performed until the sum of coin(s) withdrawn from the first storage unit 11 has become a predetermined amount or until the number of coin(s) withdrawn from the first storage unit 11 or the number of coin(s) of a predetermined denomination(s) withdrawn from the first storage unit 11 has become a predetermined number. Further, the collection operation may be performed until the sum of coin(s) remaining in the first storage unit 11 has become a predetermined amount or until the number of coin(s) remaining in the first storage unit 11 or the number of coin(s) of a predetermined denomination(s) has become a predetermined number.

The various operations as illustrated in FIGS. 5A to 5D are implemented by the CPU 16 controlling the respective configurations of the coin storage apparatus 1 depending on the kind of operation.

As described above, in the coin storage apparatus 1 according to Embodiment 2, coins that have been fed out from the feeding unit 13 are recognized by the recognition unit 15 and are then transported to different transport destinations depending on the kind of operation and the recognition result.

### <Embodiment 3>

In Embodiment 3, the replenishment operation in the coin storage apparatus 1, in which the second storage unit 12 is replenished with a coin from the first storage unit 11 (see FIGS. 3 and 5C), will be described in more detail.

As described in Embodiments 1 and 2, in the replenishment operation in which the second storage unit 12 is replenished with a coin from the first storage unit 11, the CPU 16 causes a plurality of coins, which has been randomly discharged from the first storage unit 11, to be fed out one by one from the feeding unit 13 and to be recognized one by one by the recognition unit 15. Then, the CPU 16 determines whether the recognized coins are stored in the second storage unit 12 based on the number of coins for each determination that have been already stored in the second storage unit 12 and the denomination(s) of the recognized coins. In Embodiment 3, details of the determination of the CPU 16 will be described.

In a case that the CPU 16 performs the determination, the CPU 16 acquires the second denomination/number-of-coins information indicating the number of coins for each denomination stored in the second storage unit 12 at that point in time from the memory 17. The CPU 16 then realizes how many coins of the same denomination(s) as the denomination(s) of the recognized coins are stored in the second storage unit 12. The CPU 16 then causes the recognized coins to be stored in the second storage unit 12 until a combination of one or a plurality of denominations of and a number (hereinafter referred to as “denomination/number-of-coins combination”) of the coins stored in the second storage unit 12 matches a denomination/number-of-coins combination indicated by at least one denomination/number-of-coins pattern among a plurality of denomination/number-of- coins patterns having been set in advance.

The plurality of denomination/number-of- coins patterns is, for example, as follows.

In a case where the coin storage apparatus 1 is an automatic settlement machine, the coin storage apparatus 1 requests a monetary amount to be settled (demanded amount), such as the price of a commodity, from the user, and withdraws, as change, a monetary amount obtained by subtracting the demanded amount from a monetary amount that has been deposited by the user. The upper limit of a monetary amount that may be withdrawn with coins as change is determined by currency. For example, for the yen, the upper limit of a monetary amount that may be withdrawn with coins as change is 999 yen. For example, for the euro, the upper limit of a monetary amount that may be withdrawn with coins as change is 4 euros 99 cents.

The minimum denomination/number-of-coins combination required as a change fund is determined in advance by currency. In the case of the yen, it is necessary to prepare, as a change fund, coins that can address every monetary amount up to 999 yen. In the case of the yen, the minimum number required of each coin is 4 one-yen coins, 1 five-yen coin, 4 ten-yen coins, 1 fifty-yen coin, 4 hundred-yen coins, and 1 five-hundred-yen coin. Further, in the case of the euro, it is necessary to prepare, as a change fund, coins that can address every monetary amount up to 4 euros 99 cents. In the case of the euro, the minimum number required of each coin is 1 one-cent coin, 2 two-cent coins, 1 five-cent coin, 1 ten-cent coin, 2 twenty-cent coins, 1 fifty-cent coin, 1 one-euro coin, and 2 two-euro coins. The minimum number required of coins for each denomination, where the coins can address every change, may be referred to as, for example, the minimum number of coins or the like.

In the replenishment operation, it is necessary to selectively store coins in the second storage unit 12 for replenishing the second storage unit 12 with the minimum number of coins. In the coin storage apparatus 1 of the present disclosure, however, the denomination(s) and number of coins discharged from the first storage unit 11 for replenishment are random as described in Embodiment 2. Accordingly, coins necessary for storing the minimum number of coins in the second storage unit 12 are not necessarily discharged from the first storage unit 11.

The above will be described with reference to a specific example. It is assumed that the second storage unit 12 stores the minimum number of cent- and euro-coins from which 1 euro 34 cents are withdrawn in a withdrawal operation. An example of coins forming 1 euro 34 cents is 2 two-cent coins, 1 ten-cent coin, 1 twenty-cent coin, and 1 one-euro coin. Accordingly, in a replenishment operation after the withdrawal operation, it is requested that the second storage unit 12 be replenished with 2 two-cent coins, 1 ten-cent coin, 1 twenty-cent coin, and 1 one-euro coin.

It is assumed that when the replenishment operation is started, for example, a predetermined number of coins discharged from the first storage unit 11 is 10 and 4 one-cent coins, 2 five-cent coins, 3 ten-cent coins, and 1 two-euro coin are discharged. In this case, given that the second storage unit 12 stores only the minimum number of coins, the coins that should be stored in the second storage unit 12 is confined to 1 ten-cent coin among the coins discharged from the first storage unit 11 and all the other coins are unnecessary. In this case, all the unnecessary coins need to be returned to the first storage unit 11 and a predetermined number of coins need to be discharged anew from the first storage unit 11. To store only the minimum number of coins in the second storage unit 12, it is necessary to repeat such an operation numerous times until the required number of coin(s) of the required denomination(s) happens to be discharged from the first storage unit 11.

For the coin storage apparatus 1 in Embodiment 3, it is assumed that coins in a denomination/number-of-coins combination(s) that can form every monetary amount that may be withdrawn as change are stored in the second storage unit 12 without sticking to the minimum number of coins. In the case of not sticking to the minimum number of coins, there is a plurality of denomination/number-of-coins combinations that can form every monetary amount that may be withdrawn as change.

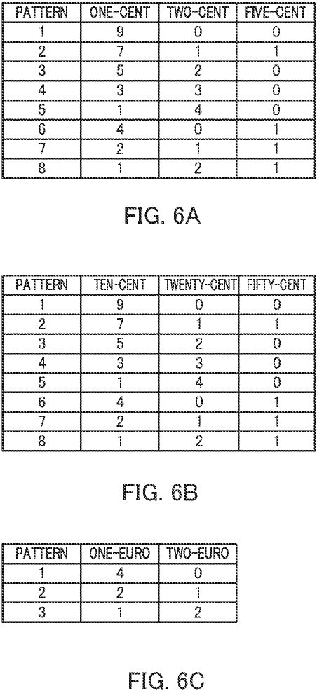

FIGS. 6A to 6C are diagrams provided for describing denomination/number-of-coins combinations that may be required as a change fund in a case where the euro is employed as a currency. FIG. 6A illustrates combinations each of which is a combination of the number of one-cent coins, the number of two-cent coins, and the number of five-cent coins, where the respective coins contribute to the one cents place of change. FIG. 6B illustrates combinations each of which is a combination of the number of ten-cent coins, the number of twenty-cent coins, and the number of fifty-cent coins, where the respective coins contribute to the ten cents place of change. FIG. 6C illustrates combinations each of which is a combination of the number of one-euro coins and the number of two-euro coins, where the respective coins contribute to the one euros (hundred cents) place.

Given three kinds of denominations of the coins that contribute to the one cents place as illustrated in FIG. 6A, there are eight patterns of combinations of denominations such that change from 1 cent to 9 cents can be formed. In the description below, the eight patterns of combinations of one-cent, two-cent, and five-cent coins that contribute to the one cents place will be referred to as denomination/number-of-coins patterns at the one cents place.

In the same manner, given also three kinds of denominations of the coins that contribute to the ten cents place as illustrated in FIG. 6B, there are eight patterns of combinations of denominations such that change from 10 cents to 90 cents can be formed. In the description below, the eight patterns of combinations of ten-cent, twenty-cent, and fifty-cent coins that contribute to the ten cents place will be referred to as denomination/number-of-coins patterns at the ten cents place.

Further, given two kinds of denominations of the coins that contribute to the one euros (hundred cents) place as illustrated in FIG. 6C, there are three patterns of combinations of denominations such that change from 1 euro to 4 euros can be formed. In the description below, the three patterns of combinations of one-euro and two-euro coins that contribute to the one euros place will be referred to as denomination/number-of-coins patterns at the one euros place.

As described above, the denomination/number-of-coins patterns indicate a plurality of combinations of the denominations and number of coins that can form change of every monetary amount at each place.

Hereinafter, the determination of the CPU 16 in the coin storage apparatus 1 according to Embodiment 3 will be described with reference to a specific example. For example, a case where a coin recognized by the recognition unit 15 is a one-cent, two-cent, or five-cent coin each of which contributes to the one cents place will be taken into consideration.

It is assumed that the denomination/number-of-coins combination of coins stored in the second storage unit 12 at a certain point in time does not match any combination in the denomination/number-of-coins patterns at the one cents place illustrated in FIG. 6A. In this case, the CPU 16 determines that every coin that has been fed out from the first storage unit 11 via the feeding unit 13 is stored in the second storage unit 12.

As the storage of coins in the second storage unit 12 progresses, the denomination/number-of-coins combination of the coins stored in the second storage unit 12 matches one of the denomination/number-of-coins patterns illustrated in FIG. 6A. For example, the pattern 4 illustrated in FIG. 6A is established when the second storage unit 12 in a state of having stored 3 one-cent coin, 2 two-cent coins, and no five-cent coin then stores a two-cent coin. Alternatively, the patterns 7 and 8 illustrated in FIG. 6A are established when the second storage unit 12 in a state of having stored 3 one-cent coins, 2 two-cent coins, and no five-cent coin then stores a five-cent coin. In this case, the CPU 16 does not cause another coin to be stored in the second storage unit 12 and causes subsequent coins to be returned to the first storage unit 11.

As described above, the CPU 16 causes every recognized coin contributing to the one cents place to be stored in the second storage unit 12 until the denomination/number-of-coins combination of coins stored in the second storage unit 12 matches one of a plurality of predetermined denomination/number-of-coins patterns. Then, after the denomination/number-of-coins combination of the coins stored in the second storage unit 12 matches one of the plurality of predetermined denomination/number-of-coins patterns, the CPU 16 causes every recognized coin contributing to the one cents place to be returned to the first storage unit 11.

Such a configuration makes it possible to determine that every coin contributing to the one cents place is stored in the second storage unit 12 until the denomination/number-of-coins combination of coins stored in the second storage unit 12 matches a combination indicated by one pattern among a plurality of denomination/number-of-coins patterns, and makes it possible to determine that after the denomination/number-of-coins combination of the coins stored in the second storage unit 12 matches a combination indicated by one pattern among the plurality of denomination/number-of-coins patterns, every coin contributing to the one cents place is returned to the first storage unit 11. That is, by causing every coin to be stored in the second storage unit 12 until the denomination/number-of-coins combination of coins stored in the second storage unit 12 matches one of denomination/number-of-coins combinations (denomination/number-of-coins patterns) that can address every monetary amount as change, the coin storage apparatus 1 according to Embodiment 3 is capable of replenishing the second storage unit 12 with a coin more efficiently than continuing to wait for a coin of a specific denomination to be discharged. Accordingly, it is no longer necessary to continue to wait for a coin of a specific denomination for which it is not known when the coin is discharged, and it is possible to implement a prompt replenishment operation on the second storage unit 12 with a coin from the first storage unit 11.

Although the coins contributing to the one cents place have been described above, a prompt replenishment operation for the coins contributing to the ten cents place can also be performed by the CPU 16 performing the same determination. In the same manner, for the coins contributing to the one euros place as well, the CPU 16 may cause one-euro or two-euro coins to be stored in the second storage unit 12 until the number of one-euro coin(s) and the number of two-euro coin(s) stored in the second storage unit 12 match those of one of the patterns 1 to 3 illustrated in FIG. 6C.

Note that, in the determination of the CPU 16 described above, unnecessarily numerous coins of a specific denomination may be stored in the second storage unit 12. For example, in the denomination/number-of-coins patterns at the one cents place illustrated in FIG. 6A, one-cent coins exceeding 9 one-cent coins, two-cent coins exceeding 4 two-cent coins or two-cent coins exceeding 1 five-cent coin are unnecessary in every pattern.

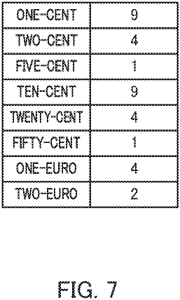

To avoid such a situation, in a case where the number of coins of a specific denomination among a plurality of coins stored in the second storage unit 12 has reached an upper limit number set in advance for each denomination, the CPU 16 determines, in addition to the determination described above, that coins of the denomination are no longer stored in the second storage unit 12. In this case, the CPU 16 causes coins of the denomination to be returned to the first storage unit 11. FIG. 7 illustrates examples of upper limit numbers. The upper limit numbers illustrated in FIG. 7 are set to be the maximum values for coins of the respective denominations in the denomination/number-of-coins patterns.

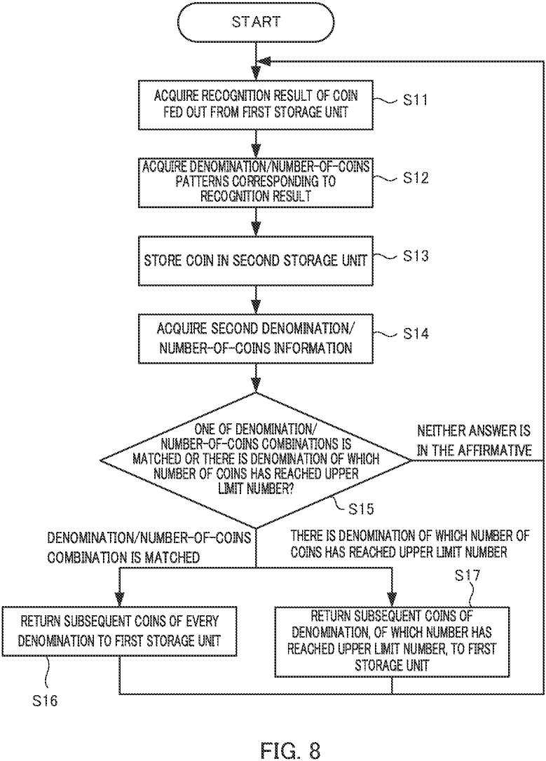

The determination of the CPU 16 described above is summarized as follows. FIG. 8 is a flowchart provided for describing the determination of the CPU 16 in the replenishment operation. Note that, it is assumed that the number of coins for each denomination stored in the second storage unit 12 is less than the number indicated by any combination comprised in the denomination/number-of-coins patterns at the starting point in time of FIG. 8.

In step S11, the CPU 16 acquires a recognition result of coins, which have been fed out one by one from the first storage unit 11 via the feeding unit 13 and have been recognized by the recognition unit 15, from the recognition unit 15.

In step S12, the CPU 16 acquires denomination/number-of-coins patterns for the place, which corresponds to the denomination of a coin acquired in step S11, from the memory 17. When a specific example is mentioned, in a case where a coin recognized in step S11 is a twenty-cent coin, the CPU 16 acquires the denomination/number-of-coins patterns for the ten cents place exemplified in FIG. 6B.

In step S13, the CPU 16 causes the coin recognized in step S11 to be stored in the second storage unit 12.

In step S14, the CPU 16 acquires the second denomination/number-of-coins information (information indicating the number of coins for each denomination stored in the second storage unit 12) at that point in time.

In step S15, the CPU 16 determines whether a denomination/number-of-coins combination indicated by the second denomination/number-of-coins information acquired in step S14 matches a denomination/number-of-coins combination indicated by one pattern among the denomination/number-of-coins patterns acquired in step 12, or whether there is a denomination of which the number of coins stored in the second storage unit 12 has reached its upper limit number. When specific examples are mentioned, in a case where the denomination/number-of-coins combination of coins stored in the second storage unit 12 is, for example, 1 ten-cent coin, 4 twenty-cent coins, and no fifty-cent coin as a result of 1 twenty-cent coin having been newly stored in the second storage unit 12 in step S13, the CPU 16 determines that the above combination matches the pattern 5 in the denomination/number-of-coins patterns for the ten cents place. Alternatively, in a case where the denomination/number-of-coins combination of coins stored in the second storage unit 12 is, for example, 3 ten-cent coins, 2 twenty-cent coins, and no fifty-cent coin as a result of 1 twenty-cent coin having been newly stored in the second storage unit 12 in step S13, the CPU 16 determines that the above combination does not match any pattern in the denomination/number-of-coins patterns for the ten cents place. Further, in a case where 4 twenty-cent coins are stored in the second storage unit 12 as a result of 1 twenty-cent coin having been newly stored in the second storage unit 12 in step S13, the CPU 16 determines that the number of twenty-cent coins has reached its upper limit number.

In a case where the CPU 16 has determined in step S15 that the denomination(s) and number of coins indicated by the second denomination/number-of-coins information match the denomination(s) and number of coins indicated by a denomination/number-of-coins pattern, the processing proceeds to step S16. Further, in a case where the CPU 16 has determined in step S15 that the number of coins of one denomination indicated by the second denomination/number-of-coins information has reached its upper limit number, the processing proceeds to step S17. In a case where the CPU 16 has determined that neither answer is in the affirmative, on the other hand, the processing returns to step S11.

In step S16, the CPU 16 controls the transport unit 14 such that every subsequent coin that has been fed out from the feeding unit 13 and has been recognized by the recognition unit 15 is returned to the first storage unit 11.

Further, in step S17, the CPU 16 controls the transport unit 14 such that, among the subsequent coins that have been fed out from the feeding unit 13 and have been recognized by the recognition unit 15, every coin of a denomination of which the number of coins has reached its upper limit number is returned to the first storage unit 11. Note that, coins of a denomination, of which the number has not reached its upper limit number, may be stored in the second storage unit 12 until the denomination(s) and number of coins indicated by the second denomination/number-of-coins information match the denomination(s) and number of coins indicated by a denomination/number-of-coins pattern.

As described above, the CPU 16 determines based on the denomination(s) and number of coins already stored in the second storage unit 12 that a denomination/number-of-coins combination of one or a plurality of coins that is ultimately stored in the second storage unit 12 is changed as appropriate depending on the denomination of a coin that has been newly fed out from the first storage unit 11 via the feeding unit 13 and has been recognized by the recognition unit 15. Such a determination makes it possible to efficiently and promptly perform the replenishment operation on the second storage unit 12.

Note that, in the above description, the CPU 16 causes coins to be stored in the second storage unit 12 until one pattern among denomination/number-of-coins patterns contributing to each place is matched. However, the CPU 16 may also cause coins to be stored in the second storage unit 12 until, for example, one denomination/number-of-coins pattern set in advance among a plurality of denomination/number-of-coins patterns is matched.

The above will be described with reference to a specific example. For example, in a case where the pattern 1 is set among the denomination/number-of-coins patterns contributing to the one cents place (sees FIG. 6A), the CPU 16 causes feeding out of coins from the first storage unit 11 via the feeding unit 13 to be repeated until 9 one-cent coins are stored in the second storage unit 12. Note that, the CPU 16 may cause two-cent and five-cent coins to be stored in the second storage unit 12 until the two-cent and five-cent coins reach their respective upper limit numbers, and causes two-cent and five-cent coins whose respective numbers are greater than their respective upper limit numbers to be returned to the first storage unit 11. In this case, even when the denomination/number-of-coins pattern combination of coins stored in the second storage unit 12 matches, for example, the pattern 2 before matching the pattern 1, the CPU 16 does not stop causing one-cent coins to be stored in the second storage unit 12, and causes feeding out of one-cent coins from the first storage unit 11 to be repeated until the number of one-cent coins has become 9.

The setting of denomination/number-of-coins patterns, which are to be set in advance, may be performed by, for example, the user via the operation unit 73.

Further, it may also be configured such that the user does not set denomination/number-of-coins patterns, but the coin storage apparatus 1 selects one denomination/number-of-coins pattern based on an operation mode and stores coins in the second storage unit 12 until the denomination/number-of-coins pattern combination of coins stored in the second storage unit 12 matches the selected denomination/number-of-coins pattern. The operation mode is, for example, a mode in which the tendency of the entire storage operation of the coin storage apparatus 1 is set, and is assumed to be, for example, a change preparation priority mode, a withdrawal priority mode, or the like. The change preparation priority mode is a mode in which a reduction in the time for storing a change fund in the second storage unit 12 is prioritized, and the withdrawal priority mode is a mode in which a reduction in the time between when change needs to be withdrawn and when the change is withdrawn is prioritized. In the change preparation priority mode, among a plurality of denomination/number-of-coins patterns, a denomination/number-of-coins pattern close to the denomination(s) and number of coins indicated by the second denomination/number-of-coins information at that point in time is set. In the withdrawal priority mode, on the other hand, a denomination/number-of-coins pattern that becomes the minimum number of coins is set. Examples of the operation mode may comprise, in addition to the examples described, a mode in which bias in the denominations of coins stored in the first storage unit 11 is reduced, and a mode in which coins of a specific denomination is preferentially discharged. In the mode in which bias in denominations is reduced, for example, a denomination/number-of-coins pattern for which coins of a denomination, of which the number is numerous, are withdrawn more in accordance with the number of coins stored in the first storage unit 11 for each denomination is set.

Note that, a denomination/number-of-coins pattern indicating a combination of coins for each denomination, which forms a change fund that is stored in the second storage unit 12, may also be defined by the number of coins for each denomination, which can be withdrawn as change, regardless of a monetary amount whose withdrawal is requested as the change. For example, in the case of the yen, coins for 999 yen suffice as coins usually prepared as change since there are banknotes for values equal to or greater than 1000 yen. In the coin storage apparatus 1, however, a denomination/number-of-coins pattern that allows change greater than 999 yen to be withdrawn (for example, a pattern that allows coins up to 1500 yen to be withdrawn as change) may be set.

Further, in the embodiment described above, a denomination/number-of-coins pattern is automatically selected in accordance with the denomination(s) and number of coins that are stored in the second storage unit 12. However, it may also be configured such that, for example, the user of the coin storage apparatus 1 can freely set the coin storage apparatus 1 as to which denomination/number-of-coins pattern among a plurality of denomination/number-of-coins patterns is used. Further, it may also be configured such that a denomination/number-of-coins pattern can be freely set in accordance with the user’s intention, such as withdrawing or not withdrawing only a coin(s) of a specific denomination.

### <Embodiment 4>

The various operations of the coin storage apparatus 1 have been described in Embodiments 1 to 3. In the present Embodiment 4, a flow of the entire operation comprising the various operations of the coin storage apparatus 1 will be described. Note that, the entire operation that will be described in Embodiment 4 comprises, among the various operations described in Embodiment 2, the deposit operation, the withdrawal operation, and the replenishment operation, but does not comprise the collection operation.

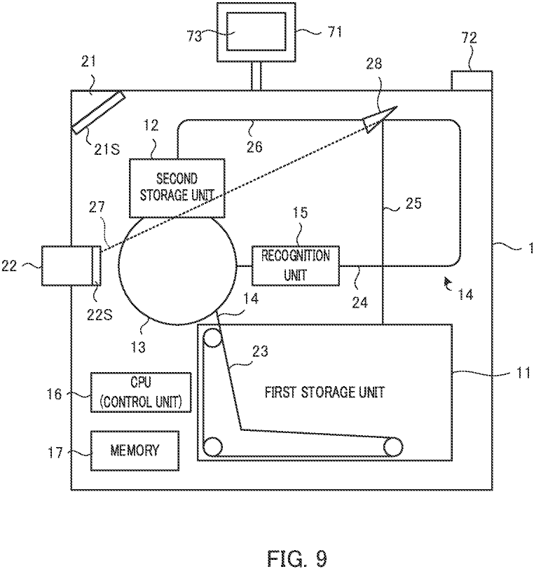

Note that, it is assumed in Embodiment 4 that the coin storage apparatus 1 comprises, in addition to the configurations illustrated in FIG. 4, an inlet shutter 21S, an outlet shutter 22S, a display 71, a sound output unit 72, and an operation unit 73 as illustrated in FIG. 9.

The inlet shutter 21S is a shutter that blocks reception of a coin at the inlet 21. The outlet shutter 22S is a shutter that makes it impossible to take out a coin from the outlet 22.

The display 71 is, for example, a display device such as a liquid crystal display or an organic EL display. The sound output unit 72 is, for example, a speaker or the like, and outputs a sound. The operation unit 73 is a device that receives an operation of the user, and is, for example, a button, a switch, a keyboard, a touch screen, a barcode reader, a two-dimensional code reader, or the like. In a case where the operation unit 73 is a touch screen, the display device as the display 71 and the touch screen as the operation unit 73 may be arranged to overlap each other.

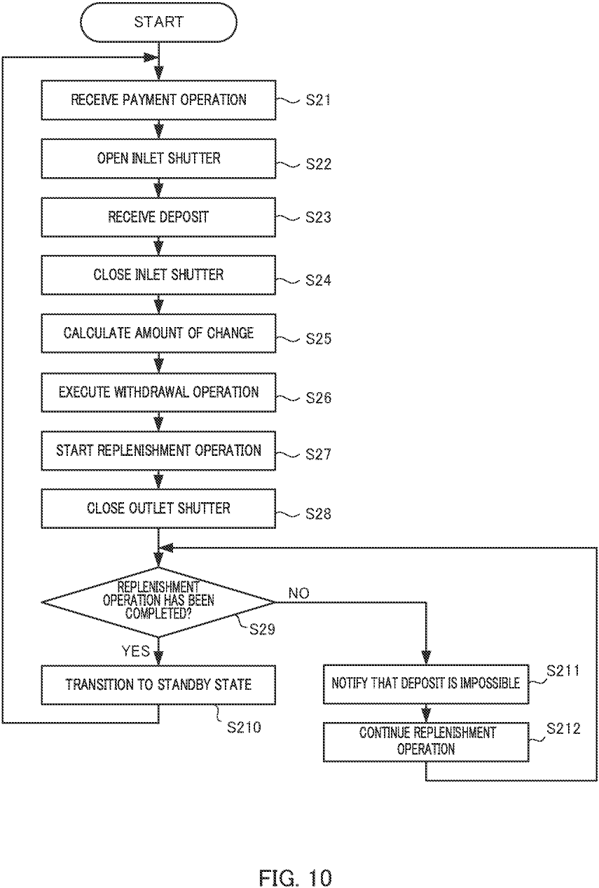

FIG. 10 is a flowchart provided for describing an example of the flow of the entire operation of the coin storage apparatus 1 according to Embodiment 4. Note that, it is assumed that the coin storage apparatus 1 has completed the replenishment operation on the second storage unit 12 and is in a state capable of receiving payment by the user at the operation starting point in time of FIG. 10.

In step S21, the coin storage apparatus 1 receives a payment operation of a new user via the operation unit 73. The payment operation of the user is an operation in which, for example, the user causes the coin storage apparatus 1 to read information on the payment. When a specific example is mentioned, the user causes the coin storage apparatus 1 to read a barcode or a two-dimensional code attached to a commodity via the operation unit 73, whereby the coin storage apparatus 1 acquires recognition information and pricing information on the commodity. Commodity information may be comprised in a barcode or a two-dimensional code or may be acquired by the coin storage apparatus 1 referring to an external commodity data server or the like based on recognition information comprised in a barcode or a two-dimensional code. In the case of payment of a fare or the like, the coin storage apparatus 1 may acquire charge information by, for example, the user pressing an independent key for each charge as the operation unit 73. With such an operation, the coin storage apparatus 1 can acquire in step S21 payment amount information indicating a monetary amount that the user should pay.

In step S22, the coin storage apparatus 1 opens the inlet shutter 21S provided at the inlet 21. At the same time, the coin storage apparatus 1 uses either the display 71 or the sound output unit 72 to notify the user that the coin storage apparatus 1 is in a state capable of receiving a deposit.

In step S23, the coin storage apparatus 1 receives the user’s deposit into the inlet 21. Thus, the coin storage apparatus 1 executes the deposit operation (see FIG. 5A).

In step S24, the coin storage apparatus 1 closes the inlet shutter 21S when the deposit has been completed.

In step S25, the coin storage apparatus 1 calculates the amount of change based on the difference between the payment amount indicated by the payment amount information acquired in step S21 and the deposited monetary amount.

In step S26, the coin storage apparatus 1 executes the withdrawal operation (see FIG. 5B) in which a coin(s) forming the amount of change is/are withdrawn. At this time, the coin storage apparatus 1 opens the outlet shutter 22S as the withdrawal operation starts.

In step S27, the coin storage apparatus 1 starts the replenishment operation (see FIGS. 3, 5C, and 7) as the withdrawal operation ends. At this point in time, the outlet shutter 22S may not be closed yet.

In step S28, the coin storage apparatus 1 closes the outlet shutter 22S in a case where the coin storage apparatus 1 has detected that the user had taken out the withdrawn change from the outlet 22. The fact that the user has taken out the withdrawn change from the outlet 22 may be detected by, for example, a sensor provided in the outlet 22 or the like.

In step S29, in a case where the replenishment operation has been completed (step S29: YES), the processing proceeds to step S210, whereas in a case where the replenishment operation has not been completed (step S29: NO), the processing proceeds to step S211.

In step S210, the coin storage apparatus 1 transitions to a standby state in which the coin storage apparatus 1 waits for a payment operation of a subsequent user. In the standby state, the coin storage apparatus 1 does not perform any of the operations described above, but waits until a user’s operation occurs.

In step S211, the coin storage apparatus 1 notifies that a payment operation of a subsequent user cannot be received. The notification may be performed by displaying a message on the display 71 or by the sound output unit 72 outputting a sound. Alternatively, it may be also configured such that, for example, a button for accepting a payment operation is not displayed on the display 71 or the button is displayed in a grayed out manner.

In step S212, the coin storage apparatus 1 continues the replenishment operation until the replenishment operation has been completed. After step S212, the processing returns to step S29.

As described above, the entire operation comprising the deposit operation, the withdrawal operation, and the replenishment operation in the coin storage apparatus 1 is executed. According to such an entire operation, the processing transitions to the replenishment operation immediately after the withdrawal operation is completed, and thus, it is possible to advance the replenishment operation while the user is taking out change from the outlet 22, for example, which increases the possibility that the replenishment operation can be completed before a subsequent user starts a payment operation.

Further, it is configured such that in a case where the replenishment operation has not been completed yet after the user takes out change from the outlet 22, the user is notified or the display 71 displays that a new payment operation cannot be performed. Thus, the user can prepare himself/herself to wait until the replenishment operation has been completed.

Note that, it may also be configured such that in a case where the replenishment operation has not been completed, a new payment operation is received and the inlet shutter 21S is not opened instead of the display 71 displaying that a new payment operation cannot be performed. In this case, the display 71 or the sound output unit 72 may be used to notify that a deposit cannot be received.

1. A coin storage method, comprising:
feeding out a coin from a first storage unit that stores a coin;
recognizing a denomination of the coin that has been fed out; and
executing, based on a number of coins for each denomination having been already stored in a second storage unit and the denomination of the coin recognized, a replenishment operation in which the coin is selectively stored in the second storage unit, wherein the second storage unit storing a coin to be withdrawn outside, wherein
the executing of the replenishment operation comprises changing, depending on the denomination of the coin having been fed out from the first storage unit, a denomination/number-of-coins combination of one or a plurality of coins to be stored in the second storage unit in the replenishment operation.

2. The coin storage method according to claim 1, wherein the executing of the replenishment operation further comprises storing the coin recognized in the second storage unit until the denomination/number-of-coins combination of the plurality of coins stored in the second storage unit matches a denomination/number-of-coins combination indicated by at least one of the plurality of denomination/number-of-coins patterns, among a plurality of denomination/number-of-coins patterns indicating a plurality of denomination/number-of-coins combinations set in advance.

3. The coin storage method according to claim 2, wherein the executing of the replenishment operation further comprises returning the coin recognized to the first storage unit after a number of the plurality of coins stored in the second storage unit for each denomination matches the denomination/number-of-coins combination indicated by one of the plurality of denomination/number-of- coins patterns.

4. The coin storage method according to claim 2, wherein the executing of the replenishment operation further comprises returning a coin of a specific denomination, among a plurality of the coins recognized, to the first storage unit, when a number of coins of the specific denomination among the plurality of coins stored in the second storage unit has reached an upper limit number set in advance for each denomination.

5. The coin storage method according to claim 4, wherein the upper limit number is a maximum value of a number of coins for each denomination indicated by the plurality of denomination/number-of-coins patterns.

6. The coin storage method according to claim 2, wherein the executing of the replenishment operation further comprises:
receiving selection of at least one specific denomination/number-of-coins pattern among the plurality of denomination/number-of- coins patterns, and
storing the coin recognized in the second storage unit until the number of the plurality of coins stored in the second storage unit for each denomination matches a number-of-coins combination for the each denomination indicated by the at least one specific denomination/number-of-coins pattern selected.

7. The coin storage method according to claim 2, wherein the executing of the replenishment operation further comprises:
selecting at least one specific denomination/number-of-coins pattern among the plurality of denomination/number-of-coins patterns based on an operation mode set in advance, and
storing the coin recognized in the second storage unit until the number of the plurality of coins stored in the second storage unit for each denomination matches a number-of-coins combination for the each denomination indicated by the at least one specific denomination/number-of-coins pattern having been selected.

8. The coin storage method according to claim 2, wherein the executing of the replenishment operation further comprises feeding out the one or plurality of coins from the second storage unit and, transpoting one or a plurality of coins that forms an amount of the withdrawal requested, among the one or plurality of coins fed out, to an outlet, when withdrawal is requested, wherein
each of the plurality of denomination/number-of-coins patterns indicates a number-of-coins combination for the each denomination, the number-of-coins combination forming a withdrawal fund to be stored in the second storage unit.

9. The coin storage method according to claim 8, wherein the executing of the replenishment operation further comprises feeding out a coin anew from the first storage unit, recognizing, and transporting a coin to the second storage unit, after transporting the plurality of coins forming the amount of the withdrawal to the outlet.

10. The coin storage method according to claim 8, wherein the executing of the replenishment operation further comprises at least one of a deposit and/or a withdrawal at the coin storage apparatus is stopped until the number of the plurality of coins stored in the second storage unit for each denomination matches the number-of-coins combination for the each denomination indicated by, among the plurality of denomination/number-of-coins patterns set in advance, at least one of the plurality of denomination/number-of-coins patterns, after transporting the plurality of coins forming the amount of the withdrawal to the outlet.

11. A coin storage apparatus, comprising:
a first storage unit that stores a plurality of coins of a plurality of denominations;
a second storage unit that stores a coin independently of the first storage unit;
an outlet through which a coin is withdrawn outside;
a transport unit that transports the coin or the plurality of coins;
a feeding unit that feeds out the coin or the plurality of coins to the transport unit, the coin or the plurality of coins having been discharged from the first storage unit and the second storage unit; and
a recognition unit that recognizes a denomination or denominations of the coin or the plurality of coins to be transported; and
a control unit that causes at least one or some of the plurality of coins discharged from the first storage unit to be stored in the second storage unit and causes at least one or some of a plurality of the coins discharged from the second storage unit to the feeding unit to be withdrawn through the outlet.

12. The coin storage apparatus according to claim 11, wherein the feeding unit that feeds out the coin or the plurality of coins to the transport unit is provided on a lower side of the second storage unit and close to the second storage unit.

13. The coin storage apparatus according to claim 11, wherein the control unit further causes the plurality of coins having been discharged from the first storage unit and having been recognized to be stored in the second storage unit until a number of a plurality of coins for each denomination matches a number-of-coins combination for the each denomination indicated by, among a plurality of denomination/number-of- coins patterns having been set in advance, at least one of the plurality of denomination/number-of- coins patterns, the plurality of coins being stored in the second storage unit.

14. The coin storage apparatus according to claim 13, the control unit further causes the coin or the plurality of coins to be returned to the first storage unit after a number of a plurality of coins for each denomination matches the denomination/number-of-coins combination indicated by one of the plurality of denomination/number-of- coins patterns, the coin or the plurality of coins having been recognized, the plurality of coins having been stored in the second storage unit.

15. The coin storage apparatus according to claim 11, wherein the second storage unit comprises a bottom part and causes the coin or the plurality of coins to fall to the feeding unit by opening the bottom part when a withdrawal is performed, the bottom part being openable and closable.
